(19) United States
(12) Patent Application Publication
(10) Pub. No.: US 2016/0157024 A1
(43) Pub. Date: Jun. 2, 2016

(54) FLIP-CHIP MEMS MICROPHONE

(71) Applicant: LINGSEN PRECISION INDUSTRIES, LTD., Taichung City (TW)

(72) Inventors: Hsien-Ken LIAO, TAICHUNG CITY (TW); Ming-Te TU, TAICHUNG CITY (TW)

(21) Appl. No.: 14/622,078

(22) Filed: Feb. 13, 2015

(30) Foreign Application Priority Data
Nov. 27, 2014 (TW) 103141135

(51) Int. Cl. H04R 19/04; H04R 19/00

(52) U.S. Cl. CPC H04R 19/04; H04R 19/005

(57) ABSTRACT

A flip-chip MEMS microphone includes a substrate having a conduction line, a metal shell capped on the substrate to define therein a first cavity and having a sound receiving hole aimed at a sensor chip that is accommodated in the metal shell and electrically connected to a processor chip in the metal shell, and a plastic part mounted at one lateral side inside the metal shell and having built therein exposed ports that are electrically connected with the conduction line and the processor chip. Thus, the flip-chip MEMS microphone provides a flip-chip package structure to increase the cavity volume, improving the signal-to-noise ratio (SNR).

### BACKGROUND OF THE INVENTION

1. Field of the Invention

The present invention relates to MEMS (micro-electromechanical system) microphone technology and more particularly, to a flip-chip MEMS microphone.

2. Description of the Related Art

For the advantages of excellent electrical properties and smaller size, MEMS (Micro-electromechanical Systems) microphones have been getting more and more attention in the field of electro-acoustic. When compared with conventional electret condenser microphones, MEMS microphones have the advantages of high electrical stability, consistent quality, small package size and ease of the use of SMT (Surface Mount Technology), etc. Therefore, the application of MEMS microphones in the field of acoustics will be more and more widespread.

The commonly known MEMS microphone package is to affix a MEMS (Micro-electromechanical Systems) and an ASIC (Application-specific Integrated Circuit) to a substrate using a die bonding process, and then to achieve conduction between the MEMS/ASIC and an external signal using a wire bonding process, and then to mount a metal shell on the outside for shielding electromagnetic interference. This design of MEMS microphone package needs to make a through hole on the metal shell or substrate for the transfer of acoustic signals to the MEMS. However, the MEMS of the aforesaid MEMS microphone package is tiny, in consequence, the volume of the cavity defined between the vibration diaphragm of the MEMS and the substrate is relatively narrow. This narrow cavity directly affects the vibration of the vibration diaphragm, lowering the sensitivity of the MEMS microphone package.

### SUMMARY OF THE INVENTION

The present invention has been accomplished under the circumstances in view. It is the main object of the present invention to provide a flip-chip MEMS microphone, which provides a flip-chip package structure to increase the cavity volume, improving the signal-to-noise ratio (SNR).

To achieve this and other objects of the present invention, a flip-chip MEMS microphone comprises a substrate, a metal shell, and a plastic part. The substrate comprises a conduction line. The metal shell is fixedly capped on the substrate to define therein a first cavity. The metal shell comprises a sound receiving hole. Further, the metal shell accommodates therein a sensor chip, and a processor chip being electrically connected to the sensor chip. The sound receiving hole is aimed at the sensor chip. The plastic part is mounted at one lateral side inside the metal shell, having built therein at least one exposed port. Each port is electrically connected with the conduction line and the processor chip.

Preferably, each port comprises a trench, and a metal coating formed on and protruding over the trench.

Preferably, the trench comprises a high junction electrically connected to the conduction line, a low junction electrically connected to the processor chip, and a slop connected between the high junction and the low junction.

Preferably, the part of the metal coating that is located at the high junction protrudes over the metal shell and touches the conduction line of the substrate.

Preferably, the metal coating is formed on the trench by chemical plating.

Preferably, the plastic part is bonded to one lateral side inside the metal shell with epoxy or a film adhesive.

Preferably, the sensor chip comprises a frame fixedly adhered to an inside wall of the metal shell, and a vibration diaphragm bonded to the frame to face toward the sound receiving hole and to constitute a second cavity.

Preferably, the volume of the first cavity is larger than the volume of the second cavity.

Preferably, the metal shell comprises a datum plane therein. Further, the plastic part, the sensor chip and the processor chip are respectively located on the datum plane of the metal shell.

Preferably, the flip-chip MEMS microphone further comprises a package colloid molded on the processor chip.

Preferably, the volume of the metal shell is 1.5 times larger than the dimension of the plastic part.

Most preferably, the volume of the metal shell is 2 times larger than the dimension of the plastic part.

Thus, the flip-chip MEMS microphone of the invention uses the plastic part to work as a medium between each chip and the substrate so that electrical conduction between each chip and the substrate can be simultaneously achieved when the metal shell is fixedly capped onto the substrate. Thus, the invention simplifies the packaging procedure and effectively suppresses electromagnetic interference. Further, through the flip-chip packaging structure, the volume of the first cavity between the vibration diaphragm of the sensor chip and the substrate is maximized, helping to enhance the vibration of the vibration diaphragm and to further improve the signal-to-noise ratio (SNR) of the flip-chip MEMS microphone.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a sectional view of a flip-chip MEMS microphone in accordance with the present invention, showing the metal shell removed and the relative position between each chip and the plastic part.

FIG. 2 is a sectional view taken along line 2-2 of FIG. 1, illustrating each chip and the plastic part mounted in the metal shell on one same plane and the ports of the plastic part electrically connected to the conduction line of the substrate.

FIG. 3 is a bottom view of the flip-chip MEMS microphone, illustrating the plastic part located at one lateral side inside the metal shell.

FIG. 4 is a sectional view taken along line 4-4 of FIG. 3, illustrating the detailed technical features of the plastic part.

### DETAILED DESCRIPTION OF THE INVENTION

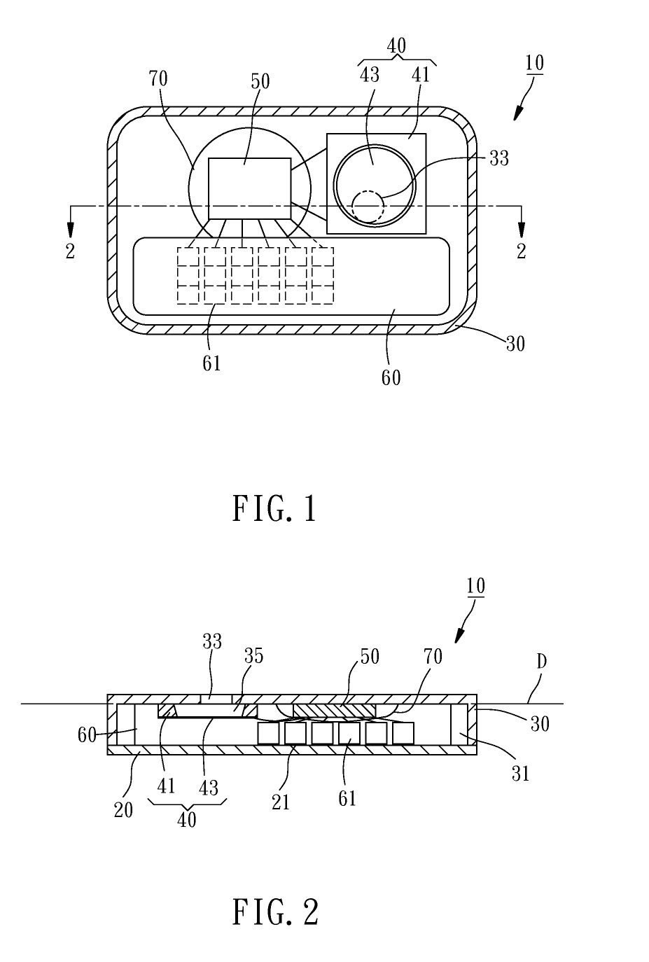

Referring to FIGS. 1 and 2, a flip-chip MEMS (micro-electromechanical system) microphone 10 in accordance with the present invention is shown. The flip-chip MEMS microphone comprises a substrate 20, a metal shell 30, a sensor chip 40, a processor chip 50, and a plastic part 60. The metal shell 30 defines therein a datum plane D. The plastic part 60, the sensor chip 40 and the processor chip 50 are respectively mounted on the datum plane D in the metal shell 30.

The substrate 20 comprises a conduction line 21. As illustrated in FIG. 2, the conduction line 21 consists of 6 metal pads.

The metal shell 30 is capped on the substrate 20 to define therein a first cavity 31. The metal shell 30 comprises a sound receiving hole 33. The metal shell 30 houses the sensor chip 40 and the processor chip 50 that is electrically connected to the sensor chip 40. The sound receiving hole 33 is aimed at the sensor chip 40. The sensor chip 40 is made using a semiconductor manufacturing process or other micro precision technology. The sensor chip 40 comprises a frame 41, and a vibration diaphragm 43. The frame 41 is fixedly adhered to an inside wall of the metal shell 30. The vibration diaphragm 43 is bonded to the frame 41 to face toward the sound receiving hole 33, thereby constituting a second cavity 35. When an external sound pressure signal is transferred through the sound receiving hole 33 into the second cavity 35 to act upon the vibration diaphragm 43, the vibration diaphragm 43 is caused to vibrate, and then to convert this signal into an electrical signal and to transmit the converted electrical signal to the processor chip 50. The processor chip 50 in this embodiment is adapted to provide the sensor chip 40 with a stabilized bias for normal operation, and to amplify the received electrical signal for output. The processor chip 50 is an ASIC (Application Specific IC) that can be a charge pump, voltage regulator, amplifier, etc. Because the flip-chip MEMS microphone 10 uses a flip-chip package structure, the volume of the first cavity 31 is larger than the second cavity 35, and the first cavity 31 defined by the vibration diaphragm 43 and the substrate 20 is relatively broad when compared to conventional MEMS microphones. These characteristics help to enhance the vibration of the vibration diaphragm, thereby improving the signal-to-noise ratio (SNR) of the flip-chip MEMS microphone 10.

The plastic part 60 is bonded to one lateral side inside the metal shell 30 with epoxy or a film adhesive. More specifically, in order to maximize the volume of the first cavity 31, the internal volume of the metal shell 30 is preferably 1.5 times larger than the dimension of the plastic part 60, or most preferably 2 times larger than the dimension of the plastic part 60. The plastic part 60 has built therein at least one exposed port 61 electrically connected to the conduction line 21 and the processor chip 50. In this embodiment, the number of the ports 61 is equal to the number of the metal pads of the conduction line 21. Further, the ports 61 are respectively set corresponding to the metal pads of the conduction line 21. Further, the connection between the sensor chip 40 and the processor chip 50 and the connection between the processor chip 50 and the ports 61 of the plastic part 60 are made with solder wires using the wire bonding technology. Further, in order to keep solder wire from breaking due to violent vibration or impact, a package colloid 70 is molded on the processor chip 50 over the connection area between the processor chip 50 and the solder wires.

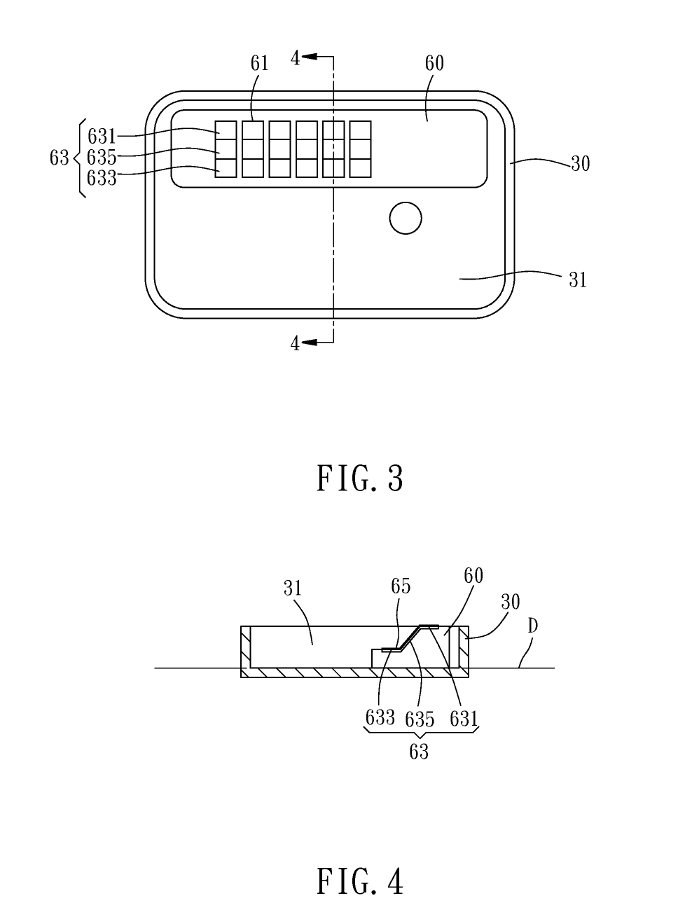

It's worth mentioning that, as shown in FIG. 3 and FIG. 4, each port 61 of the plastic part 60 comprises a trench 63 and a metal coating 65. The metal coating 65 is not a lead frame punched out of a metal sheet or metal band, it is formed on the trench 63 by chemical plating. For enabling the metal coating 65 and the conduction line 21 to be electrically connected together after the metal shell 30 and the substrate 20 are fixedly fastened together, the metal coating 65 protrudes over the trench 63 to reduce the risk of circuit disconnection and to eliminate the problem of bad contact. More specifically, the trench 63 comprises a high junction 631, a low junction 633, and a slope 635 connected between the high junction 631 and the low junction 633. The part of the metal coating 65 that is located at the high junction 631 slightly protrudes over the metal shell 30 so that the metal coating 65 can accurately touch the conduction line 21 of the substrate 20. The part of the metal coating 65 that is located at the low junction 633 is electrically connected to the processor chip 50.

In conclusion, the flip-chip MEMS microphone 10 uses the plastic part 60 to work as a medium between each chip 40,50 and the substrate 30 so that electrical conduction between each chip 40,50 and the substrate 30 can be simultaneously achieved when the metal shell 30 is fixedly capped onto the substrate 20, and thus, the invention simplifies the packaging procedure and effectively suppresses electromagnetic interference. Further, through the flip-chip packaging structure, the volume of the first cavity 35 between the vibration diaphragm 43 of the sensor chip 40 and the substrate 20 is maximized, helping to enhance the vibration of the vibration diaphragm and to further improve the signal-to-noise ratio (SNR) of the flip-chip MEMS microphone 10.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A flip-chip MEMS microphone, comprising:
a substrate comprising a conduction line;
a metal shell fixedly capped on said substrate to define therein a first cavity, said metal shell comprising a sound receiving hole, said metal shell accommodating therein a sensor chip and a processor chip being electrically connected to said sensor chip, said sound receiving hole being aimed at said sensor chip; and
a plastic part mounted at one lateral side inside said metal shell, said plastic part having built therein at least one exposed port, each said port being electrically connected with said conduction line and said processor chip.

2. The flip-chip MEMS microphone as claimed in claim 1, wherein each said port comprises a trench, and a metal coating formed on and protruding over said trench.

3. The flip-chip MEMS microphone as claimed in claim 2, wherein said trench comprises a high junction electrically connected to said conduction line, a low junction electrically connected to said processor chip, and a slop connected between said high junction and said low junction.

4. The flip-chip MEMS microphone as claimed in claim 3, wherein the part of said metal coating that is located at said high junction protrudes over said metal shell and touches said conduction line of said substrate.

5. The flip-chip MEMS microphone as claimed in claim 2, wherein said metal coating is formed on said trench by chemical plating.

6. The flip-chip MEMS microphone as claimed in claim 1, wherein said plastic part is bonded to one lateral side inside said metal shell with epoxy or a film adhesive.

7. The flip-chip MEMS microphone as claimed in claim 1, wherein said sensor chip comprises a frame fixedly adhered to an inside wall of said metal shell, and a vibration diaphragm bonded to said frame to face toward said sound receiving hole and to constitute a second cavity.

8. The flip-chip MEMS microphone as claimed in claim 7, wherein the volume of said first cavity is larger than the volume of said second cavity.

9. The flip-chip MEMS microphone as claimed in claim 1, wherein said metal shell comprises a datum plane therein; said plastic part, said sensor chip and said processor chip are respectively located on said datum plane of said metal shell.

10. The flip-chip MEMS microphone as claimed in claim 1, further comprising a package colloid molded on said processor chip.

11. The flip-chip MEMS microphone as claimed in claim 1, wherein the volume of said metal shell is 1.5 times larger than the dimension of said plastic part.

12. The flip-chip MEMS microphone as claimed in claim 1, wherein the volume of said metal shell is 2 times larger than the dimension of said plastic part.
